(19) United States
(12) Patent Application Publication
(10) Pub. No.: US 2016/0252193 A1
(43) Pub. Date: Sep. 1, 2016

(54) SUPPORT FOR CONNECTING OR REMOVING A VALVE OR FITTING FROM A FLANGE

(71) Applicant: Courtenay Exploration Inc., Edam (CA)

(72) Inventor: James COURTENAY, Penticton (CA)

(21) Appl. No.: 14/940,640

(22) Filed: Nov. 13, 2015

(30) Foreign Application Priority Data
Feb. 27, 2015 (CA) 2883284

(51) Int. Cl. F16L 1/06; F16L 3/00; F16K 51/00

(52) U.S. Cl. CPC F16L 1/06; F16K 51/00; F16L 3/00

(57) ABSTRACT

There is provided a support for connecting or removing a valve or fitting from a flange, the flange having a front face, a rear face, and pin receiving holes that extend through the flange. The support has a backing plate having two or more connection points that align with two or more pin receiving holes of the flange, the connection points permitting the backing plate to be pin connected to the rear face of the flange and a support member carried by the backing plate below the connection points and extending laterally from the backing plate such that, when the backing plate is pin connected to the rear face of the flange, the support member extends past the front face of the flange to define a support surface that supports a valve or fitting to be connected or removed from the flange.

### TECHNICAL FIELD

This relates to a support used to connect or remove a valve or fitting from a flange.

### BACKGROUND

Valves or other fittings are often attached to flanges, and may require to be removed for cleaning or other maintenance operations. Valves and other fittings may be cumbersome or may require to be attached in hard to reach places. U.S. Pat. No. 4,223,431 (Skeels) teaches a tool for mounting or removing valve springs.

### SUMMARY

According to an aspect, there is provided a support for connecting or removing a valve or fitting from a flange, the flange having a front face, a rear face, and pin receiving holes that extend through the flange, the support comprising a backing plate having two or more connection points that align with two or more pin receiving holes of the flange, the connection points permitting the backing plate to be pin connected to the rear face of the flange and a support member carried by the backing plate below the connection points and extending laterally from the backing plate such that, when the backing plate is pin connected to the rear face of the flange, the support member extends past the front face of the flange to define a support surface that supports a valve or fitting to be connected or removed from the flange.

According to another aspect, the connection points may comprise pin receiving holes of the backing plate in combination with removable bolts.

According to another aspect, the connection points may comprise pins attached to the backing plate.

According to another aspect the pins may be welded to the backing plate.

According to another aspect the support member may comprise first and second support rods.

According to another aspect the support member may comprise a support channel.

According to another aspect, the flange may comprise eight pin receiving holes and the connection points may be separated by two pin receiving holes when the backing plate is connected to the flange.

According to another aspect, the support member may be spaced below the connection points such that it is immediately below the flange when connected.

According to another aspect, the connection points may comprise a plurality of positions on the backing plate.

According to another aspect, the support may further comprise a set screw that engages the flange.

According to an aspect, there is provided a method of connecting or removing a valve or fitting from a flange using a support, the flange having a front face, a rear face, and pin receiving holes that extend through the flange, the method comprising the steps of aligning a backing plate of the support with the two or more pin receiving holes of the flange such that the backing plate is pin connected to the rear face of the flange, the backing plate having two or more connection points, attaching the backing plate to the flange by connecting the connection points to the pin receiving holes of the flange, supporting a valve or fitting with a support member carried by the backing plate below the connection points and extending laterally from the backing plate such that, when the backing plate is pin connected to the rear face of the flange, the support member extends past the from face of the flange to define a support surface, the valve or fitting being supported by this support surface, connecting or disconnecting the valve or fitting to or from the flange while the valve or fitting is supported by the support member, and detaching the backing plate from the flange by disconnecting the connection points and removing the support.

According to another aspect, the connection points may comprise pin receiving holes of the backing plate in combination with removable bolts.

According to another aspect, the connection points may comprise pins attached to the backing plate.

According to another aspect, the pins may be welded to the backing plate.

According to another aspect, the support member may comprise first and second support rods.

According to another aspect, the support member may comprise a support channel.

According to another aspect, the flange may comprise eight pin receiving holes and the connection points may be separated by two pin receiving holes when the backing plate is connected to the flange.

According to another aspect, the support member may be spaced below the connection points such that it is immediately below the flange when connected.

In other aspects, the features described above may be combined together in any reasonable combination as will be recognized by those skilled in the art.

According to another aspect, the connection points may comprise a plurality of positions on the backing plate.

According to another aspect, the support may further comprise a set screw that engages the flange.

### BRIEF DESCRIPTION OF THE DRAWINGS

These and other features will become more apparent from the following description in which reference is made to the appended drawings, the drawings are for the purpose of illustration only and are not intended to be in any way limiting, wherein:

FIG. 1 is a side elevation view of a support for connecting or removing a valve or fitting from a flange in context with a flange and valve shown in broken lines.

FIG. 2 is a side elevation view of a support for connecting or removing a valve or fitting from a flange.

FIG. 3 is a front elevation view of a support for connecting or removing a valve or fitting from a flange in context with a flange shown in broken lines.

FIG. 4 is a front elevation view of a support for connecting or removing a valve or fitting from a flange.

FIG. 5 is a side elevation view of an alternative support for connecting or removing a valve or fitting from a flange in context with a flange and valve shown in broken lines.

FIG. 6 is a side elevation view of the alternative support for connecting or removing a valve or fitting from a flange.

FIG. 7 is a front elevation view of the alternative support for connecting or removing a valve or fitting from a flange in context with a flange shown in broken lines.

FIG. 8 is a front elevation view of the alternative support for connecting or removing a valve or fitting from a flange.

FIG. 9 is a front elevation view of an alternative support having two connectors.

FIG. 10 is a front elevation view of an alternative support having slots for adjusting the position of the pins.

FIG. 11a-c are front elevation views of an alternative support having an interchangeable backing plate.

FIG. 12 is a perspective view of an alternate support for connecting or removing a valve or fitting from a flange having threaded bolts and attached to a flange.

FIG. 13 is a side elevation view of the support of FIG. 12 attached to a flange.

FIG. 14 is a front elevation view of the support of FIG. 12 attached to a flange.

FIG. 15 is a perspective view of the support of FIG. 12.

FIG. 16 is a side elevation view of the support of FIG. 12.

FIG. 17 is a front elevation view of the support of FIG. 12.

FIG. 18 is a perspective view of an alternate support for connecting or removing a valve or fitting from a flange having pins and attached to a flange.

FIG. 19 is a side elevation view of the support of FIG. 18 attached to a flange.

FIG. 20 is a front elevation view of the support of FIG. 18 attached to a flange.

FIG. 21 is a perspective view of the support of FIG. 18.

FIG. 22 is a side elevation view of the support of FIG. 18.

FIG. 23 is a front elevation view of the support of FIG. 18.

FIG. 24 is a perspective view of an alternate support for connecting or removing a valve or fitting from a flange having an adjustable support.

FIG. 25 is a front elevation view of an alternate support having a flange that allows for diagonal attachment.

FIG. 26 is a front elevation view of an alternative support having rotating plates for adjusting the position of the pins.

### DETAILED DESCRIPTION

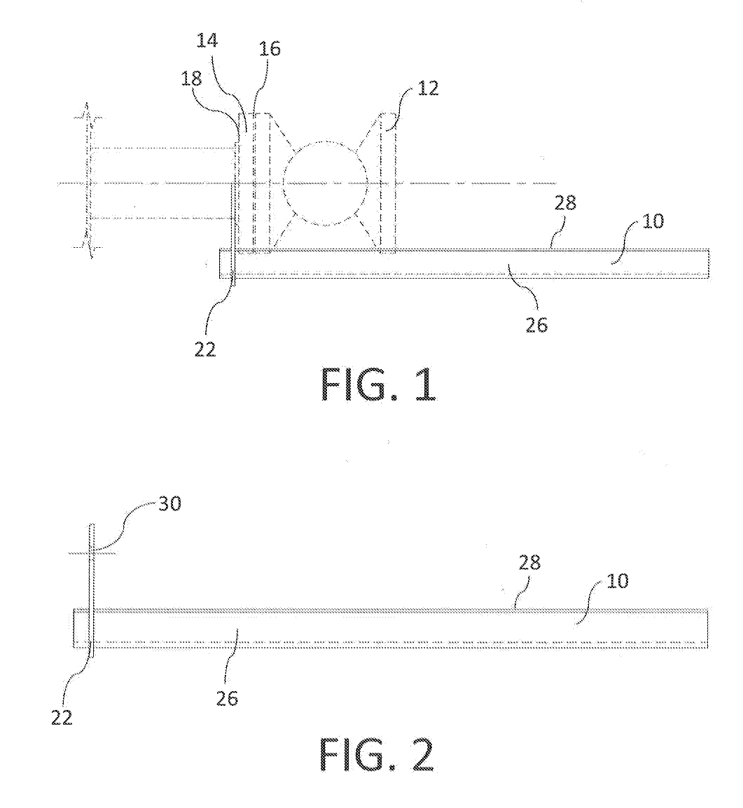

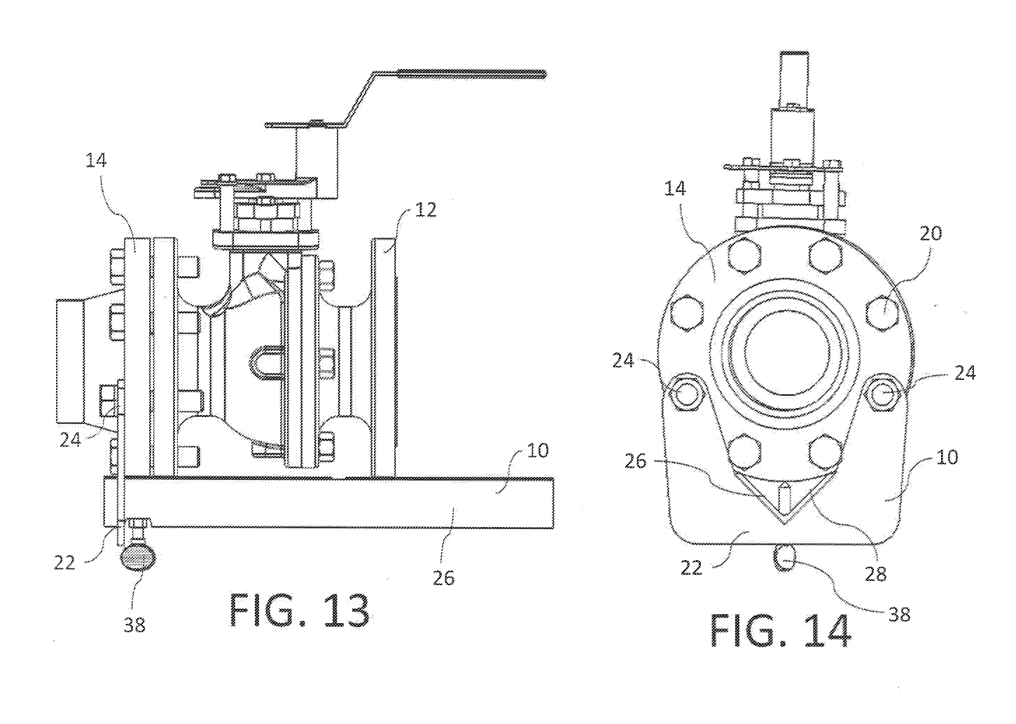

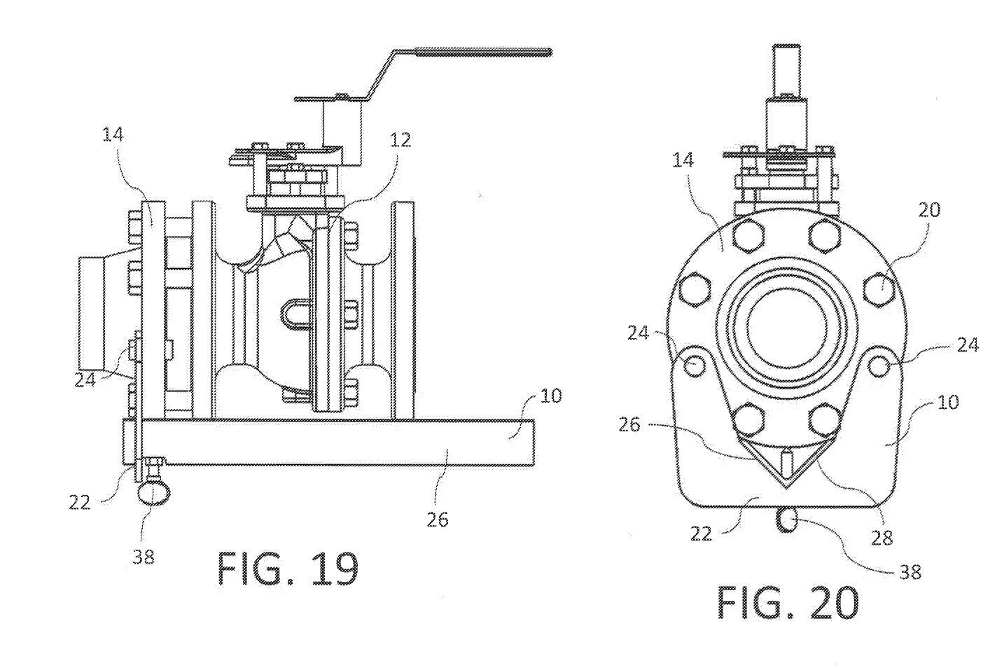

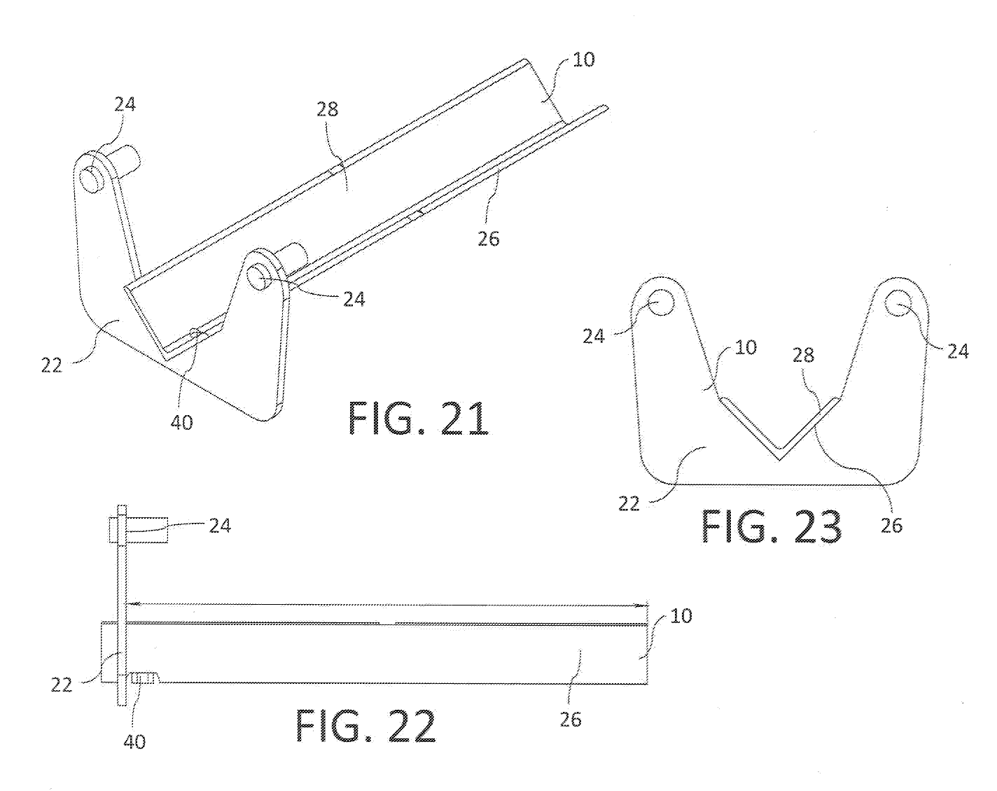

A support for connecting or removing a valve or fitting from a flange, generally identified by reference numeral 10, will now be described with reference to FIG. 1 through 24.

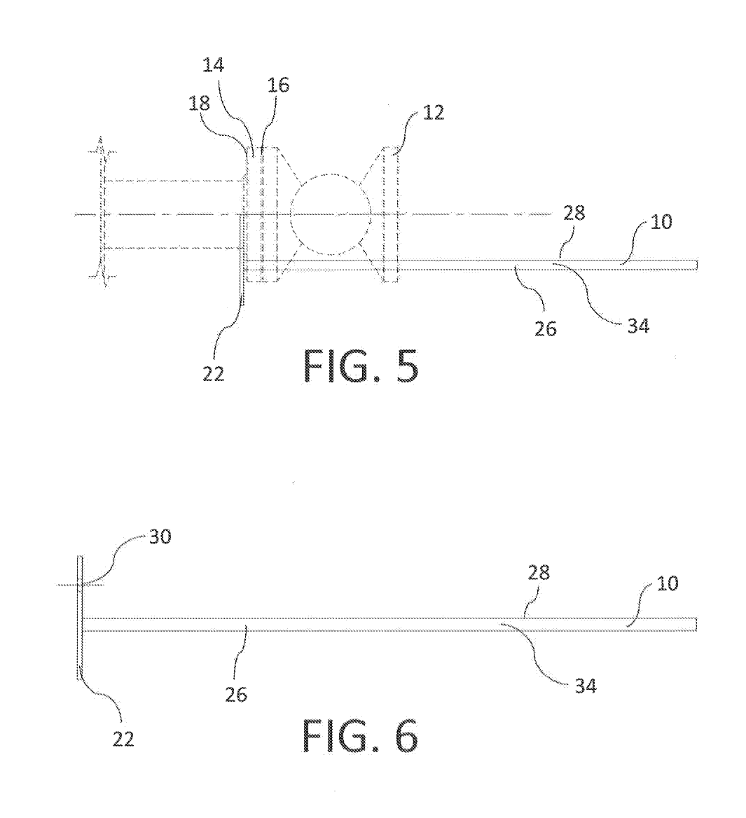

Referring to FIG. 1 and FIG. 5, support 10 is used for connecting or removing a valve 12 from a flange 14. While a valve 12 is depicted, it will be understood that support 10 may be used to attach other items to flange 14, such as fittings. The discussion below will be with respect to valves as this is the more common connection, but it will be understood that the principles may be extended to other equipment. Support 10 is particularly intended to assist with the installation or removal of equipment from vertically oriented flanges (i.e. with a vertical front face) in locations with limited access, such as in locations with a low ceiling, which would otherwise require a worker to carry valve 12 in a stooped position, or other situations that may present a risk to the worker, such as areas without sound footing. Support 10 is intended to allow the worker to handle valve 12 in a way that is safer and easier. Support 10 may also be used to assist with aligning valve 12 and flange, such that support 10 carries the weight of valve 12 while the worker installs the necessary flange bolts.

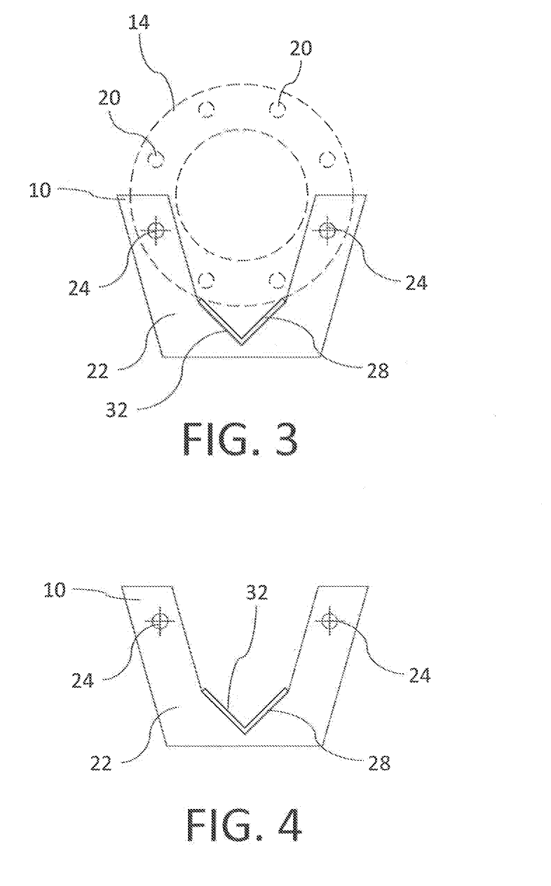

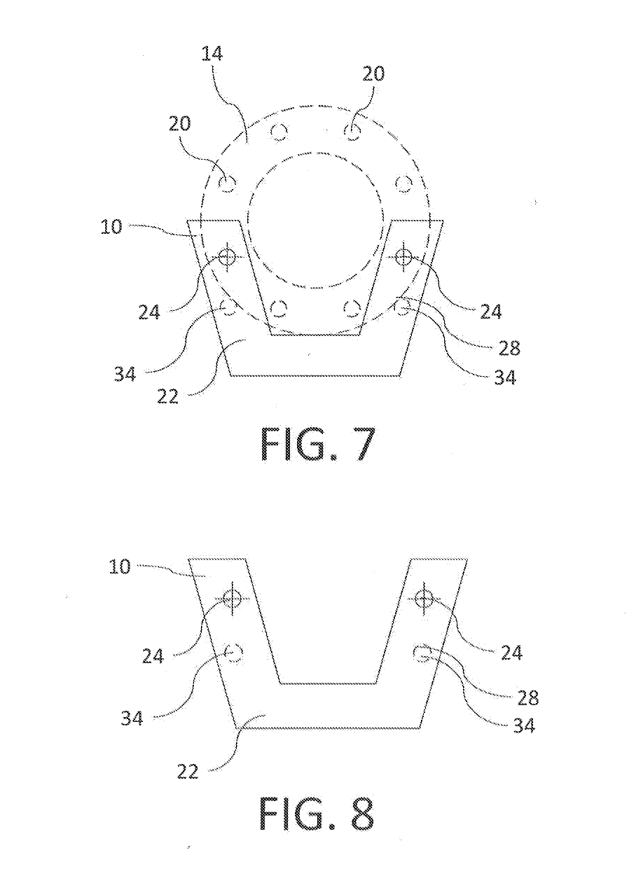

Flange 14 has a front face 16 and a rear face 18, and pin receiving holes 20 (shown in FIGS. 3 and 7) that extend through flange 14. As shown, flange 14 is a circular flange having eight pin receiving holes 20 commonly found in industry. However, support 10 may be used with other flange designs, such as flanges that are larger or smaller with a different numbers of pin receiving holes 20, etc.

Referring to FIGS. 3 and 7, support 10 has a backing plate 22 having two or more connection points 24 that align with pin receiving holes 20. Connection points 24 permit backing plate 22 to be pin connected to the rear face 18 of flange 14. It will be understood that connection points 24 may take a variety of forms. For example, connection points 24 may be pin receiving holes 30 in backing plate 22 as shown in FIG. 2 that receive removable pins, which may be bolts, to connect with flange 14. In this example, the pins pass through holes 30 and are received within holes 20 in flange 14 and the weight of support 10 and valve 12 is sufficient to secure the position of support 10 relative to flange 14. Alternatively, connection points 24 may have permanently attached pins, which may be affixed to backing plate 22 permanently, such as by welding, or removably, such as by a releasable connection. In addition, connection points 24 are shown to correspond with the top two holes on the bottom half of flange 14. This design was chosen for convenience and stability, however support 10 may engage other holes as will be recognized by those skilled in the art, or may engage additional holes of flange 14.

Referring to FIG. 2 and FIG. 6, support 10 has a support member 26 that is carried by backing plate 22 below connection points 24. Support member 26 extends laterally from backing plate 22 such that when backing plate 22 is mounted to rear face 18 of flange 14, support member 16 extends past front face 16 of flange 14 to define a support surface 28. Support surface 28 supports valve 12 when valve 12 is being connected or removed from the flange. Support surface 28 may take a variety of forms, such as a support channel 32 as shown in FIG. 1 through FIG. 4, or as first and second support rods 34 as shown in FIG. 5 through FIG. 8. Support member 26 has a length that is sufficient to allow valve 12 to be supported in a convenient location. For example, valves may be installed on or removed from a flange that is located inside an enclosure of an oil well production tank, such as are sold under the name Envirovault™. In that case, support member 26 is preferably long enough to extend out from the enclosure and allow a worker to position or remove valve 12 on or from support member 26 without having to enter the enclosure. Support member 26 is preferably spaced below connection points 24 such that support member 26 is immediately below flange 14 when connected for ease of alignment and connection between flange 14 and valve 12, although it will be understood that support member 26 may be spaced higher or lower depending on the requirements of the particular situation in which support 10 is used.

When it is desired to connect or remove valve 12 from flange 14, backing plate 22 is positioned behind flange 14 such that connection points 24 are aligned with pin receiving holes 20 of flange 14. Backing plate 22 is then mounted to rear face 18 of flange 14, such as by pins attached to backing plate 22, or by passing bolts through pin receiving holes 30 in backing plate 22 and pin receiving holes 20 in flange 14 and fastening the bolts. In the case of pins, the diameter of the pins will be smaller than the inner diameter of holes 20 and 30 such that they are able to slide in. If flange 14 is also not threaded, the bolts that would otherwise be used to mount valve 12 may be used as the pins.

Once backing plate 22 is mounted to flange 14, support member 26 will extend out past the front face of flange 14 in a cantilevered fashion. The weight of support member 26 will increase the engagement between connection points 24 and holes 20 of flange 14. A valve 12 can then be supported by support member 26.

When valve 12 is being installed, such as in location where access to flange 14 may be limited, valve 12 is placed on support member 26 at a convenient location for the worker and slid along support member 26 to align with flange 14. Valve 12 is then partially connected to flange 14, such as by connecting two or more flange bolts until flange 14 is able to support valve 12. At this point, support 10 can be removed by withdrawing the pin connectors from flange 14 and the remaining flange bolts installed to properly connect valve 12 to flange 14. When valve 12 is being removed, at least some flange bolts that attach valve 12 and flange 14 are removed to allow support 10 to be mounted to flange 14 as described above. At the least, the flange bolts that align with connection points 24 must be removed, and for convenience, the other bolts on the lower half may also be removed. Backing plate 22 is then mounted to rear face 18 of flange 14 using connection points 24 such that support member 26 is positioned below valve 12. The remaining flange bolts that connect valve 12 to flange 14 are then removed, at which point the weight of valve 12 is borne by support member 26. Valve 12 may then be removed or slid along support member 26 to a more convenient location and removed, as desired. Backing plate 22 may then be detached from flange 14 and support 10 removed.

Support 10 may be constructed from a variety of materials, depending on the use of support 10 and the requirements of the user. It will be understood by those skilled in the art that any material used for flanges may also be used for the construction of support 10. For example, support 10 may be made from steel, fibre-glass, plastic, or aluminium. Support 10 may also be constructed using a variety of techniques to attach the component parts, such as welding, casting, molding, forging, pinning, clipping, clamping, etc.

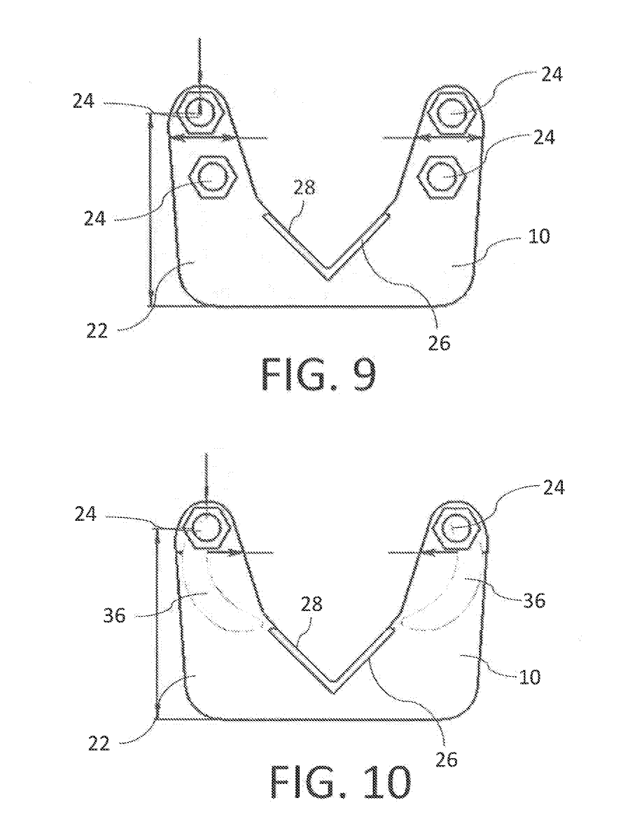

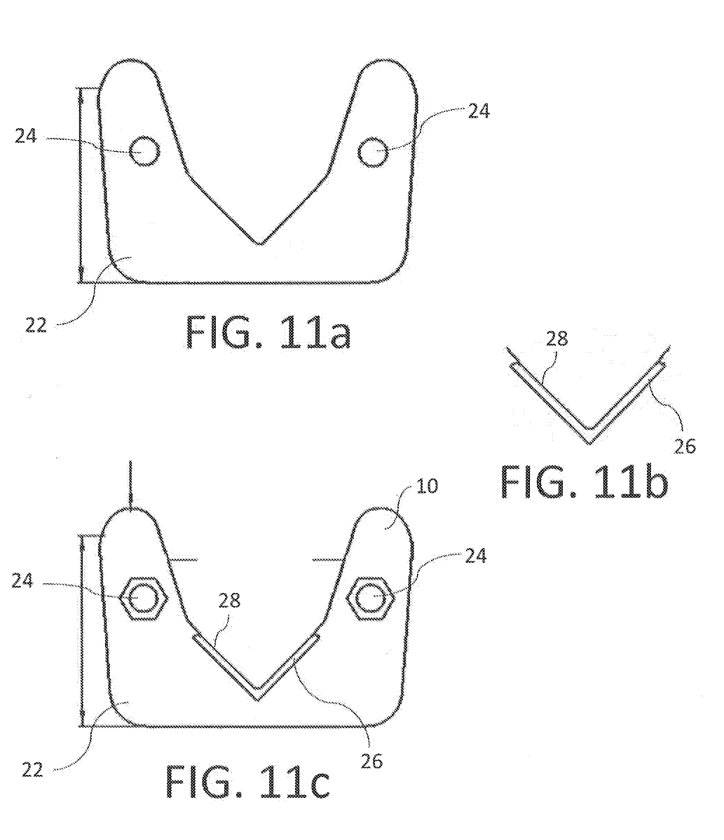

Referring to FIG. 9 through FIG. 26, examples of modifications that may be made to support 10 will be discussed. As shown in FIG. 9, backing plate 22 may have different numbers and locations of connection points 24, depending on the application, as will be understood by those skilled in the art, such as four connection points 24 as shown. Backing plate 22 may have as many connection points 24 as are required for any given application. Referring to FIG. 10, backing plate 22 may also have slots 36 as part of connection points 24. This allows connection points 24 to be adjustable to different heights and positions along slots 36. Slots 36 may have a variety of shapes, depending on the desired positions for the connection points 24. Referring to FIG. 26, the locations of connection points 24 may also be made adjustable through the use of rotating discs 48. Rotating discs 48 may, for example, have a bearing structure that allows rotating discs 48 to be freely rotated. Rotating discs 48 may also use other rotation mechanisms as are known in the art, and may also have positioning mechanisms such as a pin or ratchet that controls rotation. Referring to FIG. 11a through 11c, support member 26 may be removably attached to backing plate 22, such that backing plate 22 or support member 26 may be interchangeable. This may, for example, allow different sizes of backing plate 22 to be used, or different configurations of backing plate 22 with connection points 24 in different locations to be attached to support member 26 as needed. Alternatively, this may allow for different support members 26 to be attached to backing plate 22 depending on the application, such as by switching between support channel 32 and support rods 34. Support member 26 may be attached using a variety of methods that are well known in the art, such as by using clips or pins.

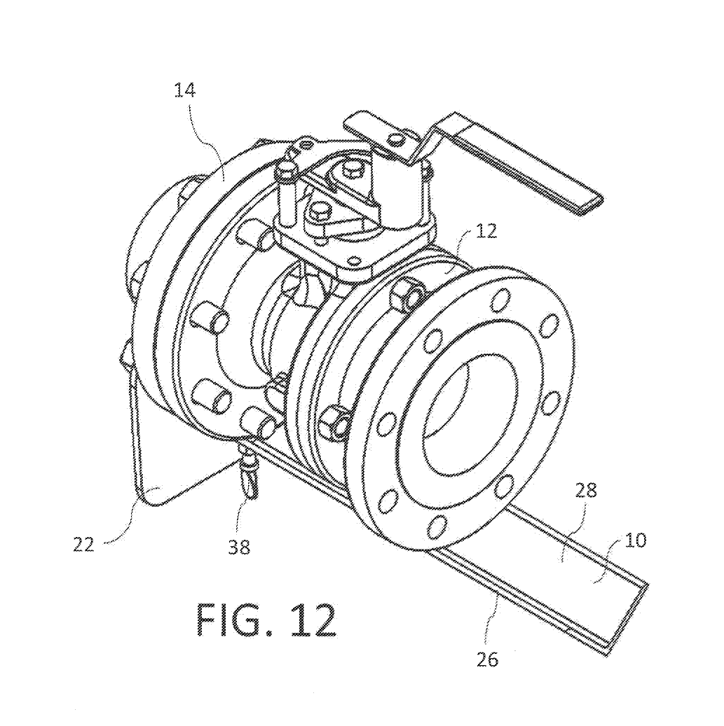

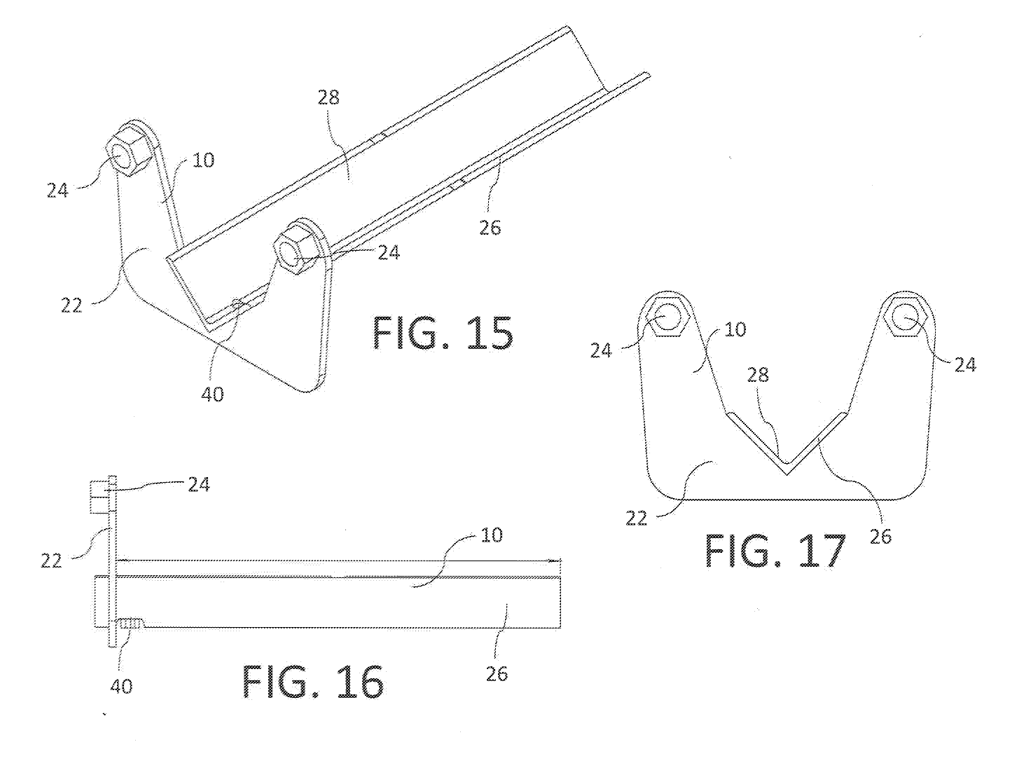

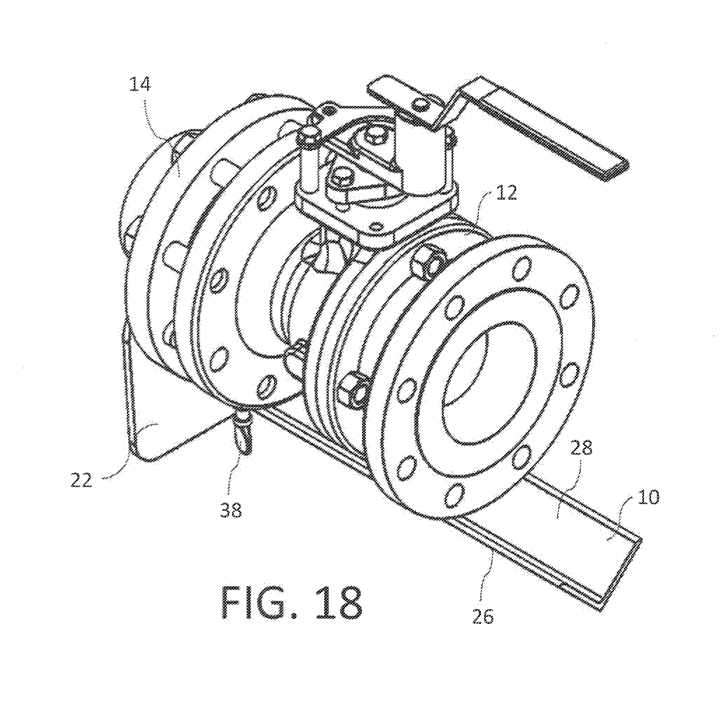

Referring to FIG. 12 through FIG. 14, depending on the application, support 10 may be left in place attached to the valve or fitting 12 while the valve or fitting 12 is connected to flange 14. In this case, connection points 24 may use threaded rods as shown, in the same manner that valve or fitting 12 is attached to flange 14. Support 10 may also have a set screw 38 as shown to help position and secure support 10 to flange 14. Referring to FIG. 15 through FIG. 17, where the threaded rods of connection points 24 have been removed for clarity, support 10 may be provided with an opening 40 in support member 26 for set screw 38. Referring to FIG. 18 through FIG. 22, a second embodiment is shown where connection points 24 are pins connected to backing plate 22. It will be understood that the depicted examples may be combined with other features as described above, for example, with different forms of support member 26, such as support rods 34 as described above, or with adjustable connection points 24 as shown in FIG. 10.

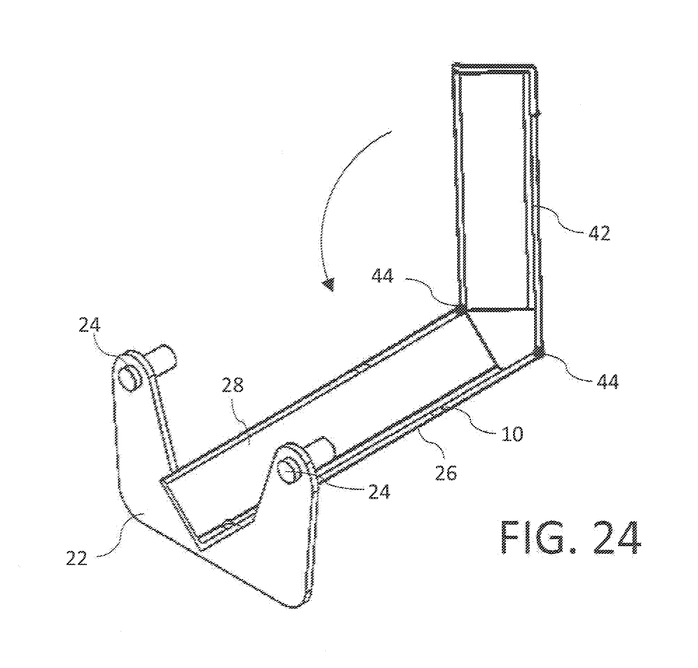

Referring to FIG. 24, support member 26 may be provided with a hinged portion 42 having hinges 44. Hinged portion 42 can be folded in order to provide a support to the valve or fitting 12 that is supported on support 10. Hinged portion 42 may be used to reduce or prevent the movement of valve or fitting 12, such as by preventing tipping, rolling, sliding, bouncing, or vibration of valve or fitting 12. Other supports (not shown) may also be attached to support member 26 to provide the same benefit.

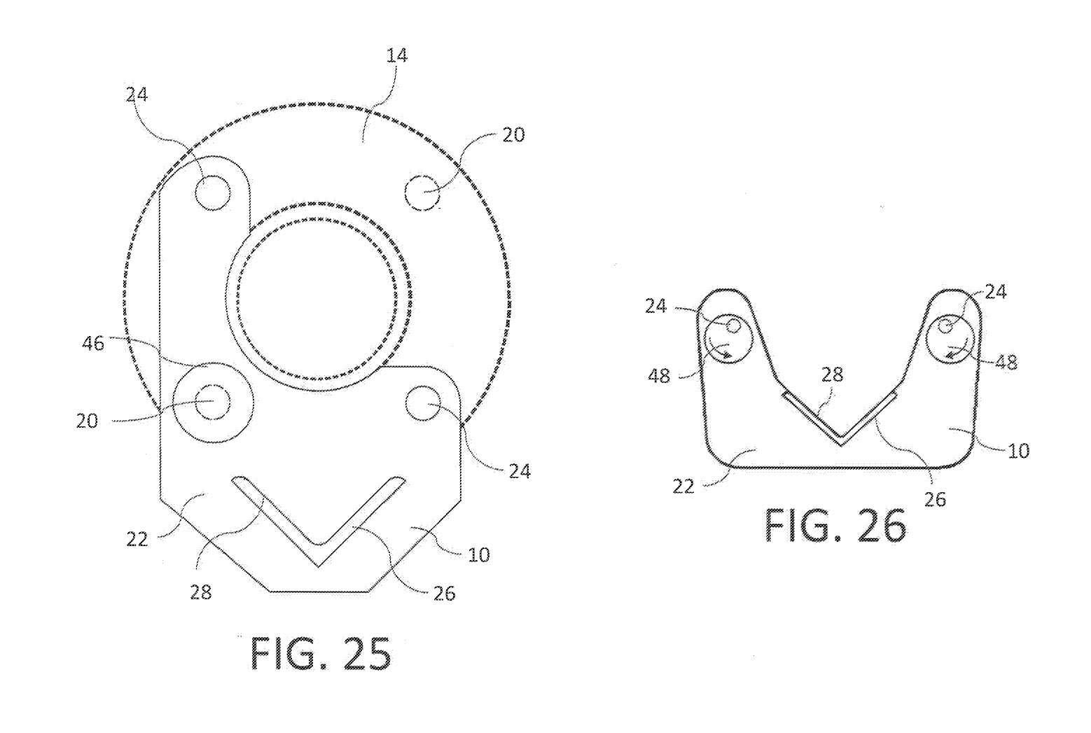

Support 10 may have different shapes depending on the number of pin receiving holes 20 and the method of attachment that is employed. For example, referring to FIG. 25, flange 14 may have four pin receiving holes 20. It may be desired to attach valve or fitting 12 in a cross-wise manner to flange 14. Backing plate 22, as shown, has two connection points 24 that are diagonally opposed to each other. Valve or fitting 12 and flange 14 may be attached through the two free pin receiving holes 20. Opening 46 in backing plate 22 is sized such that a socket or bolt may be passed through opening 46. After connecting through the two pin receiving holes 20, support 10 may be removed, allowing for the other two connections to be formed in the other two pin receiving holes 20 that previously held connection points 24. Alternatively, as described above, the connection may be formed through backing plate 22, and support 10 may remain attached to valve or fitting 12 and flange 14. It will be understood that backing plate 22 may also take other shapes depending on the application. For example, flange 14 may not be continuous, and may, for example, have two wings, as would be found on a hub valve, having two pin receiving holes 20. In this case, it may be necessary to provide a backing plate 22 and connection points 24 that are intended to remain connected with valve or fitting 12. Alternatively, support 10 may be either unbolted or remain installed once valve or fitting 12 is sufficiently supported by flange 14. As will be understood from the above examples, the term “flange” is intended to be broadly interpreted to include various types of attachments that may be engaged by a support designed using the principles described herein.

In this patent document, the word “comprising” is used in its non-limiting sense to mean that items following the word are included, but items not specifically mentioned are not excluded. A reference to an element by the indefinite article “a” does not exclude the possibility that more than one of the elements is present, unless the context clearly requires that there be one and only one of the elements.

The scope of the following claims should not be limited by the preferred embodiments set forth in the examples above and in the drawings, but should be given the broadest interpretation consistent with the description as a whole.

What is claimed:

1. A support for connecting or removing a valve or fitting from a flange, the flange having a front face, a rear face, and pin receiving holes that extend through the flange, the support comprising:
a backing plate having two or more connection points that align with two or more pin receiving holes of the flange, the connection points permitting the backing plate to be pin connected to the rear face of the flange; and
a support member carried by the backing plate below the connection points and extending laterally from the backing plate such that, when the backing plate is pin connected to the rear face of the flange, the support member extends past the front face of the flange to define a support surface that supports a valve or fitting to be connected or removed from the flange.

2. The support of claim 1, wherein the connection points comprise pin receiving holes of the backing plate in combination with removable bolts.

3. The support of claim 1, wherein the connection points comprise pins attached to the backing plate.

4. The support of claim 3, wherein the pins are welded to the backing plate.

5. The support of claim 1, wherein the support member comprises first and second support rods.

6. The support of claim 1, wherein the support member comprises a support channel.

7. The support of claim 1, wherein the flange comprises eight pin receiving holes and the connection points are separated by two pin receiving holes when the backing plate is connected to the flange.

8. The support of claim 1, wherein the support member is spaced below the connection points such that it is immediately below the flange when connected.

9. The support of claim 1, wherein the connection points comprise a plurality of positions on the backing plate.

10. The support of claim 1, wherein the support further comprises a set screw that engages the flange.

11. A method of connecting or removing a valve or fitting from a flange using a support, the flange having a front face, a rear face, and pin receiving holes that extend through the flange, the method comprising the steps of:
aligning a backing plate of the support with the two or more pin receiving holes of the flange such that the backing plate is pin connected to the rear face of the flange, the backing plate having two or more connection points;
attaching the backing plate to the flange by connecting the connection points to the pin receiving holes of the flange;
supporting a valve or fitting with a support member carried by the backing plate below the connection points and extending laterally from the backing plate such that, when the backing plate is pin connected to the rear face of the flange, the support member extends past the front face of the flange to define a support surface, the valve or fitting being supported by this support surface;
connecting or disconnecting the valve or fitting to or from the flange while the valve or fitting is supported by the support member; and
detaching the backing plate from the flange by disconnecting the connection points and removing the support.

12. The method of claim 11, wherein the connection points comprise pin receiving holes of the backing plate in combination with removable bolts.

13. The method of claim 11, wherein the connection points comprise pins attached to the backing plate.

14. The method of claim 13, wherein the pins are welded to the backing plate.

15. The method of claim 11, wherein the support member comprises first and second support rods.

16. The method of claim 11, wherein the support member comprises a support channel.

17. The method of claim 11, wherein the flange comprises eight pin receiving holes and the connection points are separated by two pin receiving holes when the backing plate is connected to the flange.

18. The method of claim 11, wherein the support member is spaced below the connection points such that it is immediately below the flange when connected.

19. The method of claim 11, wherein the connection points comprise a plurality of positions on the backing plate.

20. The method of claim 11, wherein the support further comprises a set screw that engages the flange.
